(19) United States
(12) Patent Application Publication
(10) Pub. No.: US 2014/0090514 A1
(43) Pub. Date: Apr. 3, 2014

(54) DRIVE SYSTEM FOR A VEHICLE

(71) Applicants: Matthias Tögel, Massbach (DE); Mathias Kopp, Bamberg (DE); Thomas Bauer, Grossbardorf (DE)

(72) Inventors: Matthias Tögel, Massbach (DE); Mathias Kopp, Bamberg (DE); Thomas Bauer, Grossbardorf (DE)

(21) Appl. No.: 14/119,778

(22) PCT Filed: May 3, 2012
(86) PCT No.: PCT/EP12/58116

§ 371 Date: Nov. 22, 2013

(30) Foreign Application Priority Data
May 31, 2011 (DE) 102011076790.8

(51) Int. Cl. F16F 15/30

(52) U.S. Cl. CPC F16F 15/30
USPC 74/574.2

(57) ABSTRACT

A drive system for a vehicle includes a drive unit having a drive member rotatable around an axis of rotation (A) and at least one centrifugal mass pendulum unit having a deflection mass carrier and a deflection mass arrangement supported at the deflection mass carrier such that it can be deflected from a basic relative position with respect to the latter by a deflection mass coupling arrangement. A radial distance of the deflection mass arrangement relative to the axis of rotation (A) thereof changes when the deflection mass arrangement is deflected from the basic relative position.

### CROSS-REFERENCE TO RELATED APPLICATIONS

This is a U.S. national stage of application No. PCT/EP2012/058116, filed on 3 May 2012, which claims priority to the German Application No. 10 2011 076 790.8, filed 31 May 2011, the content of both incorporated herein by reference.

### BACKGROUND OF THE INVENTION

1. Field of the Invention

The present invention is directed to a drive system for a vehicle comprising a drive unit with a drive member which is rotatable around an axis of rotation and at least one centrifugal mass pendulum unit with a deflection mass carrier and a deflection mass arrangement which is supported at the deflection mass carrier such that it can be deflected from a basic relative position with respect to the latter by means of a deflection mass coupling arrangement. A radial distance of the deflection mass arrangement relative to the axis of rotation thereof changes when the deflection mass arrangement is deflected from the basic relative position.

2. Related Art

A drive system with a drive unit formed as internal combustion engine and with a transmission is known from DE 10 2008 057 647 A1. A hydrodynamic torque converter is arranged in the torque path between the internal combustion engine and the transmission. The housing and, therefore, the impeller of the hydrodynamic torque converter can be driven in rotation by the internal combustion engine, and the turbine of the hydrodynamic torque converter is coupled with a driven hub acting as a driven member. This driven hub in turn transmits the torque to a transmission input shaft.

A torsional vibration damper arrangement with two torsional vibration dampers acting in series lies in the torque path between a lockup clutch of the hydrodynamic torque converter and the driven hub. Each of these torsional vibration dampers comprises a primary side and a secondary side which can be deflected with respect to the associated primary side against the restoring action of a respective damper element arrangement. The secondary side of the first torsional vibration damper following the lockup clutch in the torque path and the primary side of the second torsional vibration damper which relays the torque to the driven hub by a secondary side form an essential part of a torsional vibration damper arrangement intermediate mass to which the turbine is also connected. Accordingly, the turbine is coupled to the driven hub via the second of the two torsional vibration dampers.

Further, a centrifugal force mass pendulum arrangement is coupled to the torsional vibration damper arrangement intermediate mass. A deflection mass carrier thereof is formed integral with, or is provided by, a cover disk element of the primary side of the second torsional vibration damper of the two torsional vibration dampers. A deflection mass arrangement comprises a plurality of mass parts which are coupled to the deflection mass carrier by pin-shaped or roller-shaped coupling elements of a deflection mass coupling arrangement. The coupling elements are movable along the guide paths in the deflection mass parts and/or deflection mass carrier. The guide paths in the deflection mass parts have radially inner vertex regions, while the guide paths in the deflection mass carrier have radially outer vertex regions. As a result, the deflection mass parts position themselves at the greatest possible distance radially from the axis of rotation of the hydrodynamic torque converter under the influence of centrifugal force. In the event of rotational accelerations brought about, for example, by rotational irregularities or vibrations, the deflection mass parts are deflected out of this basic relative position with respect to the deflection mass carrier in that the coupling elements move along guide paths proceeding from the respective vertex regions. Owing to the curved shape of the guide paths, the deflection mass parts shift radially inward and absorb potential energy.

Through selection of the mass or mass moment of inertia of the deflection mass parts on the one hand and the curvature of the guide paths on the other hand, it is possible to tune a centrifugal force mass pendulum unit of the type mentioned above to a determined excitation order which is to be eliminated, i.e., absorbed, as far as possible. Since the natural vibration frequency of a centrifugal force mass pendulum arrangement of this kind changes as rotational speed changes and, therefore, also as the centrifugal force changes, it substantially remains tuned to a determined excitation order so that the latter can be absorbed over the entire rotational speed range.

### SUMMARY OF THE INVENTION

It is an object of the present invention to provide a drive system for a vehicle which can achieve an improvement in the cancellation of vibrations excited in the operating state.

According to a first aspect of the present invention, this object is met by a drive system for a vehicle comprising a drive unit with a drive member which is rotatable around an axis of rotation and at least one centrifugal mass pendulum unit with a deflection mass carrier and a deflection mass arrangement which is supported at the deflection mass carrier such that it can be deflected from a basic relative position with respect to the latter by means of a deflection mass coupling arrangement, wherein a radial distance of the deflection mass arrangement relative to the axis of rotation thereof changes when the deflection mass arrangement is deflected from the basic relative position, further comprising a torsional vibration damper arrangement with two torsional vibration dampers acting in series, wherein a secondary side of a first torsional vibration damper of the two torsional vibration dampers and a primary side of a second torsional vibration damper of the two torsional vibration dampers form at least a part of a torsional vibration damper arrangement intermediate mass, and the centrifugal force mass pendulum unit is coupled to the torsional vibration damper arrangement intermediate mass, wherein the centrifugal force mass pendulum unit is tuned to an absorption order at a predetermined deviation below an excitation order to be damped by the centrifugal force mass pendulum unit.

When a centrifugal force mass pendulum arrangement is coupled to a torsional vibration damper arrangement intermediate mass an at least slight intentionally induced detuning of the vibration-exciting system with respect to the exciting order to be damped such that the absorption order to which the centrifugal force mass pendulum unit is tuned lies below the actual excitation order to be damped results in an advantageous absorption behavior over the entire rotational speed spectrum. When the centrifugal force mass pendulum unit is coupled in this manner, the downward deviation of the absorption order with respect to the excitation order is generally noncritical, and excessive excited vibrations of the deflection mass arrangement, i.e., excessive increases in vibration, can be prevented by means of this deliberately induced detuning. In particular, the centrifugal force mass pendulum unit can be prevented in this way from acting so as to reinforce an excited vibration.

In this connection, the deviation can be in the range of from 0.001 to 0.1, preferably 0.01 to 0.05.

According to a further aspect of the present invention, the above-stated object is met through a drive system for a vehicle comprising a drive unit with a drive member which is rotatable around an axis of rotation and at least one centrifugal mass pendulum unit with a deflection mass carrier and a deflection mass arrangement which is supported at the deflection mass carrier such that it can be deflected from a basic relative position with respect to the latter by means of a deflection mass coupling arrangement, wherein a radial distance of the deflection mass arrangement relative to the axis of rotation thereof changes when the deflection mass arrangement is deflected from the basic relative position, further comprising a torsional vibration damper arrangement with a primary side and a secondary side which is rotatable with a driven member, preferably driven hub, and which is rotatable relative to the primary side against the restoring action of a damper element arrangement, wherein the centrifugal force mass pendulum unit is coupled to the secondary side of the torsional vibration damper arrangement and/or the driven member, and the centrifugal force mass pendulum unit is tuned to an absorption order lying at a predetermined deviation above an excitation order to be damped by the centrifugal force mass pendulum unit.

It has been shown that when the centrifugal force mass pendulum unit is coupled to the output region of a torsional vibration damper arrangement a deliberate detuning by deviation of the absorption order upward from the excitation order to be damped per se contributes to an advantageous absorption behavior preventing excessive increases in vibration.

The torsional vibration damper arrangement can be located, for example, in the torque transmission path between a friction surface formation of a clutch arrangement and the driven member, i.e., for example, a driven hub.

The above-described deliberate detuning of a centrifugal force mass pendulum unit has proven particularly advantageous when the drive system according to the invention further comprises a hydrodynamic coupling arrangement, for example, a torque converter, with a housing arrangement which is filled or finable with fluid and with an impeller which is rotatable with the housing arrangement and a turbine which is coupled to the driven member, wherein the torsional vibration damper arrangement is arranged between the clutch arrangement formed as lockup clutch and the driven member.

According to a further aspect of the present invention, the above-stated object is met through a drive system for a vehicle comprising a drive unit with a drive member which is rotatable around an axis of rotation and at least one centrifugal mass pendulum unit with a deflection mass carrier and a deflection mass arrangement which is supported at the deflection mass carrier such that it can be deflected from a basic relative position with respect to the latter by means of a deflection mass coupling arrangement, wherein a radial distance of the deflection mass arrangement relative to the axis of rotation thereof changes when the deflection mass arrangement is deflected from the basic relative position, wherein the centrifugal force mass pendulum unit is coupled to the drive member and is tuned to an absorption order lying at a predetermined deviation above an excitation order to be damped by the centrifugal force mass pendulum unit.

A deliberate detuning by setting the absorption order above the excitation order to be damped per se is also particularly advantageous with respect to the achievable absorption behavior and prevention of excessive vibration when the centrifugal force mass pendulum unit acts on the driven member. For this purpose, the centrifugal force mass pendulum unit can be coupled to the drive member together with a flywheel arrangement or via a flywheel arrangement, for example.

The flywheel arrangement can be formed, for example, as a rigid flywheel, for example, for a dry friction clutch, so that the centrifugal force mass pendulum unit in this flywheel arrangement also acts directly on the drive member when coupled via the flywheel arrangement. Alternatively, the flywheel arrangement can comprise a primary side which is rotatable with the drive member around the axis of rotation and a secondary side which is rotatable with respect to the primary side around the axis of rotation against the restoring action of a damper element arrangement, and the centrifugal force mass pendulum unit is coupled to the secondary side of the flywheel arrangement. Accordingly, in this case the flywheel arrangement can act as a dual mass flywheel which can also form the input region for a friction clutch.

According to a further aspect of the present invention, the above-stated object is met through a drive system for a vehicle comprising a drive unit with a drive member which is rotatable around an axis of rotation and at least one centrifugal mass pendulum unit with a deflection mass carrier and a deflection mass arrangement which is supported at the deflection mass carrier such that it can be deflected from a basic relative position with respect to the latter by means of a deflection mass coupling arrangement, wherein a radial distance of the deflection mass arrangement relative to the axis of rotation thereof changes when the deflection mass arrangement is deflected from the basic relative position, further comprising a transmission arrangement with at least one input shaft which can be driven in rotation by the drive member, wherein the centrifugal force mass pendulum unit is coupled to a transmission component following the at least one input shaft in the torque path and is tuned to an absorption order which lies at a predetermined deviation above an excitation order to be damped by the centrifugal force mass pendulum unit.

In this configuration according to the invention, the clutch arrangement is accordingly connected in the torque path only after the input shaft of a transmission arrangement so that the stiffness, i.e., torsional stiffness, of the input shaft can be used, or is to be taken into account, as a further vibration system particularly when vibration is excited in the region of the drive unit, and a very advantageous absorption behavior can be achieved by taking into account more extensively the deliberately induced deviation of the absorption order above the excitation order.

When deviating the absorption order above the excitation order, it is advantageous when the deviation is in the range of from 0.01 to 0.2, preferably 0.02 to 0.1.

The configuration provided according to the invention with deliberately induced detuning of a vibration system can be applied in a particularly advantageous manner when the drive unit comprises an internal combustion engine. In an internal combustion engine, particularly an inline multicylinder engine, a sequence of vibration-exciting events is generated by the essentially uniform angular distance with respect to the revolution of the crankshaft, which events can be propagated in the downstream drivetrain with corresponding periodicity and then damped by the centrifugal force mass pendulum unit provided and configured according to the invention.

In this respect, for example, the excitation order can be determined by the following formula:

O=A_{Z}×0.5,

where
O=excitation order
A_{Z}=quantity of cylinders of the internal combustion engine.

Thus it is taken into account here that, particularly in a four-cycle internal combustion engine, there is firing, that is, a vibration-exciting event, in each cylinder with every two revolutions of the crankshaft. This means that when, as is commonly the case, the excitation frequency is related to the rotational speed of the internal combustion engine, the quantity of vibration-exciting events per revolution corresponds to half of the quantity of cylinders present. For example, when a four-cylinder four-cycle inline internal combustion engine rotates at a rotational speed of 3,000 revolutions per minute, this corresponds to a rotational speed of 50 revolutions per second. Since the orders are generally related to the rotational speed of the crankshaft, the first order in this state corresponds to a frequency of 50/s. But since two vibration-exciting events, i.e., two ignitions, take place per revolution, an excitation frequency of 100/s is propagated in the drivetrain which therefore corresponds to the second order with respect to the rotational speed of the internal combustion engine or crankshaft thereof. Correspondingly, in a six-cylinder four-cycle inline internal combustion engine, the third order is critical—again in relation to rotational speed—since three of the six cylinders fire per revolution and therefore three vibration-exciting events take place per revolution.

### BRIEF DESCRIPTION OF DRAWINGS

The present invention will be described in detail in the following with reference to the accompanying drawings. In the drawings:

FIG. 1 is an axial view of a centrifugal force mass pendulum unit;

FIG. 2 is a schematic view of a first embodiment of a drive system;

FIG. 3 is a schematic view of a second embodiment of a drive system;

FIG. 4 is a schematic view of a third embodiment of a drive system;

FIG. 5 is a schematic view of a fourth embodiment of a drive system;

FIG. 6 is a schematic view of a fifth embodiment of a drive system; and

FIG. 7 is a partial view of a construction of the drive system shown in FIG. 2.

### DETAILED DESCRIPTION OF THE PRESENTLY PREFERRED EMBODIMENTS

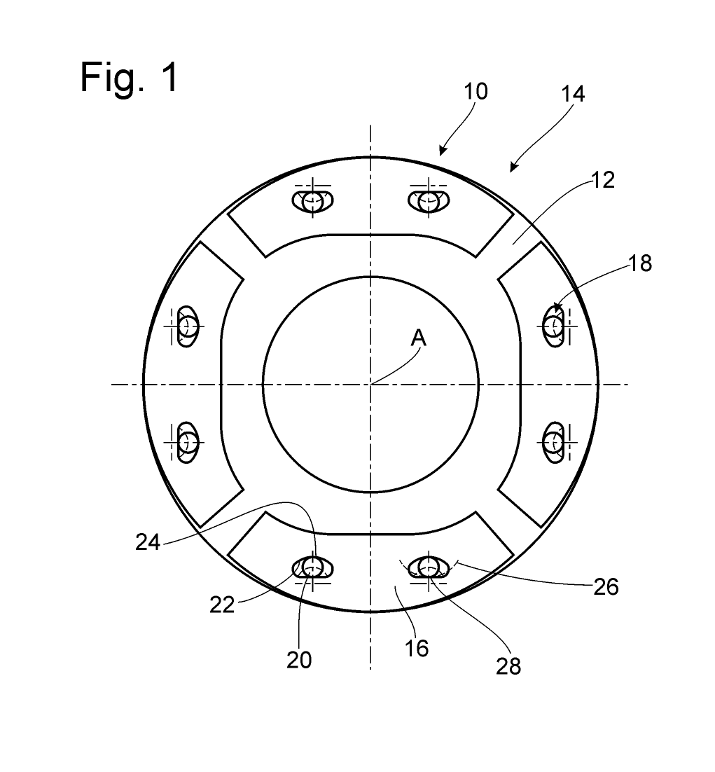

A centrifugal force mass pendulum unit 10, generally referred to as a speed-adaptive damper, is shown in an axial view, i.e., considered in direction of an axis of rotation A, in FIG. 1. This centrifugal force mass pendulum unit 10 comprises a deflection mass carrier 12 formed, for example, as an annular disk and a deflection mass arrangement 14 with a plurality of deflection mass parts 16 arranged successively in circumferential direction around the axis of rotation A. These deflection mass parts 16 can in turn be formed of two parts, for example, so that one part of a deflection mass part 16 can be located on each axial side of the deflection mass carrier 12.

A deflection mass coupling arrangement, designated generally by 18, comprises, for example, two roller-shaped coupling elements 20 associated with each deflection mass part 16, these coupling elements 20 being arranged at a circumferential distance from one another. A guide path 22 with a radially inner vertex region 24 is provided in the deflection mass parts 16 so as to be associated with each of these coupling elements 20. Correspondingly, a guide path 26 is provided in the deflection mass carrier 12 so as to be associated with each coupling element 20 as is shown, for example, in dashed lines at bottom right in FIG. 1, these guide paths 26 having a radially outer vertex region 28. The coupling elements 20 can move along the guide paths 22, 26 while carrying out a rolling movement and/or a sliding movement. Under the influence of centrifugal force, the deflection mass parts 16 are located in the position shown in FIG. 1 in which the coupling elements are positioned in the two guide paths 22, 26 associated respectively with the latter in the respective vertex region 24, 28.

When rotational accelerations of the deflection mass carrier 12 occur, the deflection mass parts 16 of the deflection mass arrangement 14 which are not rigidly connected to the deflection mass carrier 12 are accelerated in circumferential direction. The result of this is that the coupling elements 20 move along the associated guide paths 22, 26 and accordingly move out of the vertex region 24, 28. As a result, the deflection mass parts 16 shift radially inward in direction of the axis of rotation A. In so doing, they absorb potential energy so that they are themselves excited to vibrate under the action of centrifugal force.

Through the selection of different configuration parameters, it is possible to tune the vibration behavior or natural frequency behavior of the centrifugal force mass pendulum unit 10 to an excitation vibration order. In particular, the masses of the deflection mass parts 16, the distance thereof from the axis of rotation A, i.e., their mass moment of inertia during rotational acceleration, and also the curvature of the guide paths 22, 26 can be influenced for this purpose.

It should be noted that FIG. 1 shows only one example of a centrifugal force mass pendulum unit 10 of this kind. This centrifugal force mass pendulum unit 10 could be constructed differently in a variety of respects. It is important that when rotational accelerations occur the deflection mass arrangement 14 or deflection mass parts 16 thereof moves radially inward against the action of centrifugal force and are accordingly excited to vibrate.

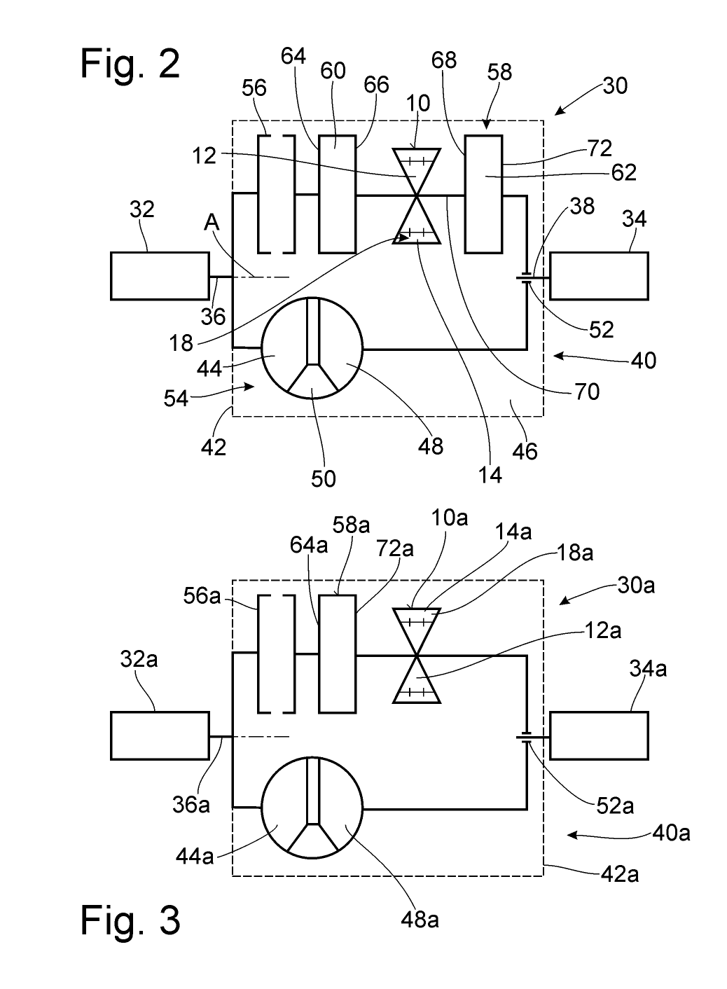

In FIG. 2, a drive system, for example, for a motor vehicle, is designated generally by 30. The drive system 30 comprises a drive unit 32 formed as or comprising, for example, an internal combustion engine. The drive system 30 further comprises a transmission arrangement 34 formed, for example, as an automatic transmission. A hydrodynamic coupling arrangement 40, which is constructed in this instance as a hydrodynamic torque converter, lies in the torque transmission path between a driveshaft 36 formed as a drive member, i.e., for example, a crankshaft of an internal combustion engine, and a transmission input shaft 38 of the transmission arrangement 34. This hydrodynamic coupling arrangement 40 comprises a housing arrangement 42, shown schematically, which is coupled to the driveshaft 36 for rotating together with the latter around the axis of rotation A. An impeller 44 can rotate together with the housing arrangement 42 around the axis of rotation A. Further, a turbine 48 and a stator 50 are provided in an interior space 46 of the housing arrangement 42, which is generally filled or finable with fluid. In the depicted embodiment example, the turbine 48 is coupled to a driven hub 52, which acts as a driven member and which is connected, for example, by toothed engagement, to the transmission input shaft 38 to rotate together with the latter.

A hydrodynamic circuit, designated generally by 54, is provided by the impeller 44, turbine 48 and stator 50. This hydrodynamic circuit 54 can reinforce the torque delivered by the drive unit 32 and can transmit it in a correspondingly reinforced manner to the transmission input shaft 38.

The hydrodynamic coupling arrangement 40 further comprises a clutch arrangement 56 which is formed as, or acts as, a lockup clutch and which can be engaged and released depending on the operating state so as to produce a direct torque transmission path between the housing arrangement 42 and the driven hub 52 parallel to the hydrodynamic circuit 54 or so as to bypass the latter. Further, a torsional vibration damper arrangement, designated generally by 58, lies in this torque transmission path. In the depicted example, this torsional vibration damper arrangement comprises two torsional vibration dampers 60, 62, which act in series. A primary side 64 of the torsional vibration damper 60, which initially follows the lockup clutch 56 in the torque path, is coupled to the output region of the lockup clutch 56 and is coupled to a secondary side 66 of the torsional vibration damper 60 for torque transmission via a damper element arrangement, not shown, which comprises, for example, a plurality of coil compression springs or the like. The primary side 64 and the secondary side 66 can rotate relative to one another, for example, around the axis of rotation A against the restoring action of this damper element arrangement.

The secondary side 66 of the first torsional vibration damper is coupled to and/or is also possibly formed integral with a primary side 68 of the second torsional vibration damper 62 following in the torque path and together with the latter forms a torsional vibration damper arrangement intermediate mass 70. A secondary side 72 of the second torsional vibration damper 62 is coupled to the primary side 68 for torque transmission via a damper element arrangement, not shown, which comprises, for example, a plurality of coil compression springs or the like and is rotatable with respect to this primary side 68, for example, around the axis of rotation A. The secondary side 72, like the turbine 48, is coupled to the driven hub 52. Accordingly, in this torsional vibration damper arrangement 58 the primary side 64 of the first torsional vibration damper 60 forms the input region thereof, while the secondary side 72 of the second torsional vibration damper 62 forms the output region thereof.

A centrifugal force mass pendulum unit 10 such as that described with reference to FIG. 1, for example, is coupled to the torsional vibration damper arrangement intermediate mass 70. The deflection mass carrier 12 thereof can provide an integral component part of the torsional vibration damper arrangement intermediate mass 70 or can be connected to a structural component part thereof.

By coupling the centrifugal force mass pendulum unit 10 to the torsional vibration damper arrangement intermediate mass 70, the centrifugal force mass pendulum unit 10 is excited to vibrate at the frequency at which the torsional vibration damper arrangement intermediate mass 70 oscillates during vibrations generated, for example, in the drive unit 32. According to the disclosed embodiments of the invention, the configuration of the absorption order of the centrifugal force mass pendulum unit 10 is selected in such a way that it is slightly below the excitation order to be damped per se, i.e., for example, the second order, with respect to the rotational speed of the driveshaft 36 in a four-cylinder four-cycle internal combustion engine. This deviation between the absorption order to which the centrifugal force mass pendulum unit 10 is tuned and the excitation order to be damped per se can be in the range of from 0.001 to 0.1, preferably 0.01 to 0.05, so that, for example, the absorption order to which the centrifugal force mass pendulum unit is tuned can be between 1.95 and 1.99.

When the centrifugal mass pendulum unit 10 is connected to the torsional vibration damper arrangement intermediate mass 70, particularly in a hydrodynamic coupling arrangement 30, a slight detuning of the absorption order below the excitation order to be damped per se accompanied by sufficient vibration excitation of the deflection mass arrangement 14 prevents the occurrence of excessive increases in vibration which can be further reinforced by the excited vibrations and, accordingly, a sufficient absorption functionality can be reliably provided over the entire rotational speed range.

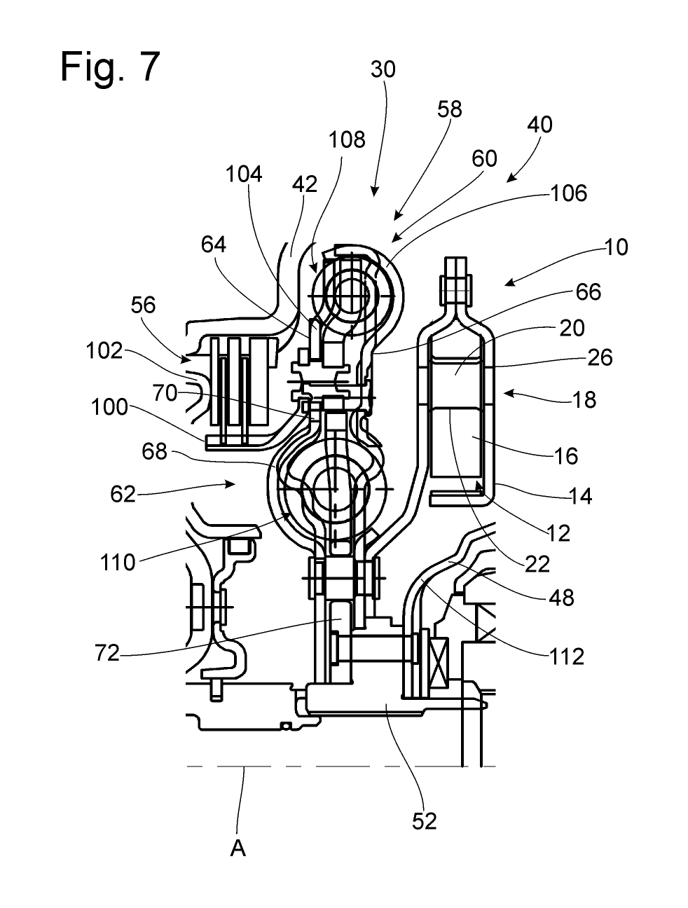

FIG. 7 shows a partial view of a drive system 30 constructed in the form of a hydrodynamic torque converter such as that which was described in outline with reference to FIG. 2. As can be seen, the clutch arrangement or lockup clutch 56 has a plurality of plate-like friction elements coupled to the housing arrangement 42 for rotating together with the latter around the axis of rotation A and a plurality of friction elements coupled with a friction element carrier 100 for rotation. A clutch piston 102, partially shown, can press these friction elements against one another to produce the engaged state.

The friction element carrier 100 is fixedly connected by riveting or the like to the primary side 64 of the radially outer first torsional vibration damper 60, which primary side 64 is constructed as a central disk element. Two cover disk elements 104, 106 at an axial distance from one another form the secondary side 66 in their outer region. Acting therebetween is a damper element arrangement 108 comprising, for example, a plurality of coil compression springs or the like.

In their radially inner area, the cover disk elements 104, 106 form the primary side 68 of the radially inner second torsional vibration damper 62. The secondary side 72 is formed with a central disk element which is fixedly connected, for example, by riveting, to the driven hub 52. A damper element arrangement 110 acts between the cover disk elements 104, 106 and the central disk element providing the secondary side 72, for example, again with a plurality of coil compression springs.

The deflection mass carrier 12 is connected, for example, by riveting, to the torsional vibration damper arrangement intermediate mass 70, which substantially comprises the cover disk elements 104, 106. This deflection mass carrier 12 is formed in the manner of a housing in its radially outer area, i.e., comprises the deflection mass parts 16 on the radially outer side, at both axial sides and partially on the radially inner side. The roller-shaped coupling elements 20 are movable along respective guide paths 22 in the deflection mass parts 16 on the one hand and guide paths 26 in the deflection mass carrier 12 on the other hand.

The turbine 48 is fastened by a turbine shell 112 thereof to the driven hub 52 on the radially inner side by riveting, for example, together with the central disk element providing the secondary side 72.

FIG. 3 shows an alternative construction of the drive system in which components whose construction or functionality corresponds to that of the components already described above are designated by the same reference numerals to which an “a” is appended.

In the embodiment shown in FIG. 3, the hydrodynamic coupling arrangement 40a is constructed with a torsional vibration damper arrangement 58a, which substantially forms only one torsional vibration damper with a primary side 64a providing the input region thereof, a secondary side 72a providing the output region thereof, and a damper element arrangement acting therebetween. The centrifugal force mass pendulum unit 10a is coupled to the secondary side 72a, i.e., the output region of the torsional vibration damper arrangement 58a, by its deflection mass carrier 12a and is accordingly substantially also directly connected to the driven hub 52a.

In a construction of this kind, the invention provides that the absorption order for which the centrifugal force mass pendulum unit 10a is configured is shifted upward with respect to the excitation order to be damped per se so that, for example, a deviation in the range of from 0.01 to 0.2, preferably 0.02 to 0.1, with respect to the excitation order to be damped per se is achieved. It has been shown that this initiates a shift in a direction that is noncritical and prevents a vibration-reinforcing effect.

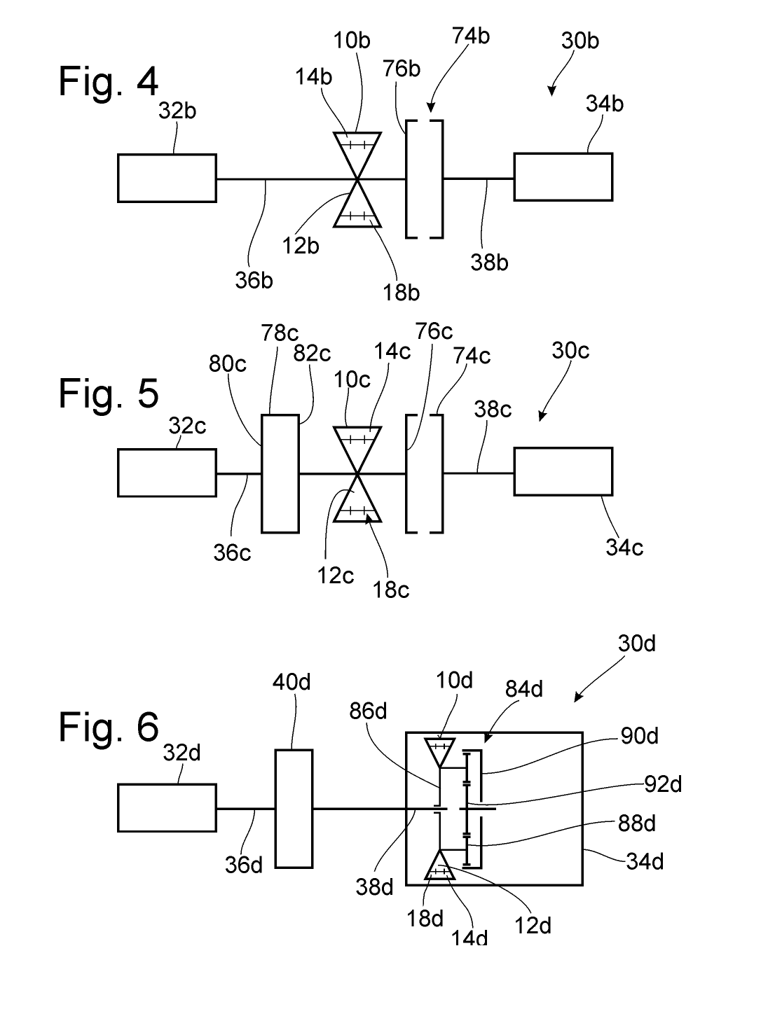

FIG. 4 shows a further exemplary embodiment of a drive system. In this case, components whose construction or functionality corresponds to that of the components already described above are designated by the same reference numerals to which a “b” is appended. For the transmission of torque between the drive unit 32b and the transmission arrangement 34b, this drive system 30b comprises a clutch arrangement 74b, which can be formed, for example, as a dry friction clutch, or possibly also as a dual clutch or multidisk clutch. An input region of this clutch arrangement 74b can comprise a flywheel 76b, which can be connected, for example, by screws, to the driveshaft 36b for rotation together with the latter. Together with the flywheel 76b, the deflection mass carrier 12d of the centrifugal force mass pendulum unit 10b is also coupled to the driveshaft 36b and is accordingly connected to it so as to rotate together with it.

In a drive system 30b constructed in this way, the absorption order to which the centrifugal force mass pendulum unit 10b is tuned is shifted upward, for example, in the deviation range indicated above, with respect to the excitation order to be damped per se.

A further drive system constructed in an alternative manner is shown in FIG. 5. In this case, components whose construction or functionality corresponds to that of the components already described above are designated by the same reference numerals to which a “c” is appended.

In this construction, a torsional vibration damper arrangement in the form of a dual mass flywheel 78c is provided in the torque transmission path between the driveshaft 36c and the clutch arrangement 74c. A primary side 80c providing the input region thereof is connected to the driveshaft 36c, while a secondary side 82c providing the output region of the dual mass flywheel is coupled to the clutch arrangement 74c or a flywheel 76c providing the input region thereof.

The centrifugal force mass pendulum unit 10c is connected by its deflection mass carrier 12c to the secondary side 82c or in the input region of the clutch arrangement 74c, i.e., is located on the secondary side with respect to the dual mass flywheel 78c.

Also in this configuration or incorporation of the centrifugal force mass pendulum unit 10c in a drive system 30c, the absorption order to which the centrifugal force mass pendulum unit 10c is tuned is shifted upward with respect to the excitation order to be damped per se, for example, again in the range of from 0.01 to 0.2, preferably 0.02 to 0.1, for preventing vibration-reinforcing effects.

Another alternative construction of the drive system is shown in FIG. 6. In this case, components whose construction or functionality corresponds to that of the components already described above are designated by the same reference numerals to which a “d” is appended.

Drive system 30d comprises the drive unit 32d and a transmission arrangement 34d constructed as automatic transmission. A first planetary gear stage 84d following the transmission input shaft 38d is shown by way of example in FIG. 6. This planetary gear stage 84d has a planet gear carrier 86d, which is connected to the transmission input shaft 38d so as to be fixed with respect to rotation relative to it, for example, by a toothed engagement or in some other manner, and which has a plurality of planet gears 88d rotatably supported thereon, a ring gear 90d meshingly engaging radially outwardly with the planet gears, and a sun gear 92d meshingly engaging radially inwardly with the planet gears. A hydrodynamic coupling arrangement 40d constructed, for example, as a hydrodynamic torque converter lies in the torque transmission path between the driveshaft 36d and the transmission input shaft 38d.

In the depicted example, the centrifugal force mass pendulum unit 10d is coupled by its deflection mass carrier 12d to the planet gear carrier 86d, i.e., a component or component assembly of the transmission arrangement 34d which follows the transmission input shaft 38d in the torque path. This means that the torsional stiffness of the transmission input shaft 38d during torque transmission between the driveshaft 36d and the transmission arrangement 34d can be considered and used as a further vibration system and the centrifugal force mass pendulum unit 10d first becomes active in the torque path after this stiffness.

According to the disclosed embodiment of the invention, the absorption order is also shifted upward with respect to the excitation order to be damped per se, for example, again in the range of from 0.01 to 0.2, preferably 0.02 to 0.1, in this configuration or integration of the centrifugal force mass pendulum unit 10d. Of course, depending on the arrangement of the internal construction of the transmission arrangement 34d, the centrifugal mass pendulum unit 10d could also be coupled to other component assemblies, for example, the ring gear 90d, or components of another planetary gear stage downstream.

The embodiment forms of the present invention which have been described above can vary in different aspects, particularly also with respect to structural features, in the construction of the different system components. Also, a drive system within the scope of the present invention can have more than one centrifugal force mass pendulum unit. For example, in the embodiment example shown in FIG. 6 the hydrodynamic coupling arrangement 40d could be constructed as shown in FIG. 2 or FIG. 3. If a plurality of centrifugal force mass pendulum units are provided, they can all be tuned upward or downward with respect to the excitation order to be damped per se in the sense described above with a predetermined deviation. In principle, however, individual centrifugal force mass pendulum units or one of a plurality of centrifugal force mass pendulum units could also be constructed with the shift to be provided according to the invention.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-12. (canceled)

13. A drive system for a vehicle, the drive system comprising:
a drive unit (32) having a drive member (36) rotatable around an axis of rotation (A);
at least one centrifugal mass pendulum unit (10) having a deflection mass carrier (12) and a deflection mass arrangement (14) supported at the deflection mass carrier (12) such that it can be deflected from a basic relative position with respect to the latter by a deflection mass coupling arrangement (18), wherein a radial distance of the deflection mass arrangement (14) relative to the axis of rotation (A) thereof changes when the deflection mass arrangement (14) is deflected from the basic relative position; and
a torsional vibration damper arrangement (58) having two torsional vibration dampers (60, 62) acting in series,
wherein a secondary side (66) of a first torsional vibration damper (60) of the two torsional vibration dampers (60, 62) and a primary side (68) of a second torsional vibration damper (62) of the two torsional vibration dampers (60, 62) form at least a part of a torsional vibration damper arrangement intermediate mass (70), and the centrifugal force mass pendulum unit (10) is coupled to the torsional vibration damper arrangement intermediate mass (70), and
wherein the centrifugal force mass pendulum unit (10) is tuned to an absorption order at a predetermined deviation below an excitation order to be damped by the centrifugal force mass pendulum unit (10).

14. The drive system according to claim 13, wherein the deviation is in the range of from 0.001 to 0.1.

15. A drive system for a vehicle, the drive system comprising:
a drive unit (32a) having a drive member (36a) rotatable around an axis of rotation (A);
at least one centrifugal mass pendulum unit (10a) having a deflection mass carrier (12a) and a deflection mass arrangement (14a) supported at the deflection mass carrier (12) such that it can be deflected from a basic relative position with respect to the latter by a deflection mass coupling arrangement (18a), wherein a radial distance of the deflection mass arrangement (14a) relative to the axis of rotation (A) thereof changes when the deflection mass arrangement (14a) is deflected from the basic relative position; and
a torsional vibration damper arrangement (58a) having a primary side (64a) and a secondary side (72a) rotatable with a driven member (52a), and rotatable relative to the primary side (64a) against the restoring action of a damper element arrangement,
wherein the centrifugal force mass pendulum unit (10a) is coupled to the secondary side (72a) of the torsional vibration damper arrangement (58a) and/or the driven member (52a), and the centrifugal force mass pendulum unit (10a) is tuned to an absorption order lying at a predetermined deviation above an excitation order to be damped by the centrifugal force mass pendulum unit (10a).

16. The drive system according to claim 13, wherein the torsional vibration damper arrangement (58; 58a) lies in the torque transmission path between a friction surface formation (56; 56a) of a clutch arrangement and a driven member (52; 52a).

17. The drive system according to claim 16, further comprising a hydrodynamic coupling arrangement (40; 40a), having a housing arrangement (42; 42a) filled or fillable with fluid and having an impeller (44; 44a) rotatable with the housing arrangement (42; 42a) and a turbine (48; 48a) coupled to the driven member (52; 52a), wherein the torsional vibration damper arrangement (58; 58a) is arranged between the clutch arrangement (56; 56a) formed as lockup clutch and the driven member (52; 52a).

18. A drive system for a vehicle, the drive system comprising:
a drive unit (32b; 32c) having a drive member (36b; 36c) rotatable around an axis of rotation (A); and
at least one centrifugal mass pendulum unit (10b; 10c) having a deflection mass carrier (12b; 12c) and a deflection mass arrangement (14b; 14c) supported at the deflection mass carrier (12b; 12c) such that it can be deflected from a basic relative position with respect to the latter by a deflection mass coupling arrangement (18b; 18c),
wherein a radial distance of the deflection mass arrangement (14b; 14c) relative to the axis of rotation thereof changes when the deflection mass arrangement (14b; 14c) is deflected from the basic relative position, and
wherein the centrifugal force mass pendulum unit (10b; 10c) is coupled to the drive member (32b; 32c) and is tuned to an absorption order lying at a predetermined deviation above an excitation order to be damped by the centrifugal force mass pendulum unit (10b; 10c).

19. The drive system according to claim 18, wherein the centrifugal force mass pendulum unit (10b; 10c) is coupled to the drive member (32b; 32c) together with, or via, a flywheel arrangement (76b; 78c).

20. The drive system according to claim 19, wherein the flywheel arrangement (78c) comprises a primary side (80c) rotatable with the drive member (32c) around the axis of rotation (A) and a secondary side (82c) rotatable with respect to the primary side (80c) around the axis of rotation (A) against the restoring action of a damper element arrangement, and in that the centrifugal force mass pendulum unit (10c) is coupled to the secondary side (82c) of the flywheel arrangement (78c).

21. A drive system for a vehicle, the drive system comprising:
a drive unit (32d) having a drive member (32d) rotatable around an axis of rotation (A);
at least one centrifugal mass pendulum unit (10d) having a deflection mass carrier (12d) and a deflection mass arrangement (14d) supported at the deflection mass carrier (12d) such that it can be deflected from a basic relative position with respect to the latter by a deflection mass coupling arrangement (18d), wherein a radial distance of the deflection mass arrangement (14d) relative to the axis of rotation (A) thereof changes when the deflection mass arrangement (14d) is deflected from the basic relative position; and
a transmission arrangement (34d) having at least one input shaft (38d) configured to be driven in rotation by the drive member (32d), wherein the centrifugal force mass pendulum unit (10d) is coupled to a transmission component (86d) following the at least one input shaft (38d) in the torque path and is tuned to an absorption order which lies at a predetermined deviation above an excitation order to be damped by the centrifugal force mass pendulum unit (10d).

22. The drive system according to claim 15, wherein the deviation is in the range of from 0.01 to 0.2.

23. The drive system according to claim 13, wherein the drive unit (32; 32a; 32b; 32c; 32d) comprises an internal combustion engine.

24. The drive system according to claim 23, wherein the excitation order is determined by the following formula:
O=A_{Z}×0.5,
where
O=excitation order
A_{Z}=quantity of cylinders of the internal combustion engine.

25. The drive system according to claim 14, wherein the deviation is in the range of from 0.01 to 0.05.

26. The drive system according to claim 15, wherein the driven member (52a) comprises a driven hub.

27. The drive system according to claim 16, wherein the driven member (52; 52a) comprises a driven hub.

28. The drive system according to claim 17, wherein the hydrodynamic coupling arrangement (40; 40a) comprises a torque converter.

29. The drive system according to claim 22, wherein the deviation is in the range of from 0.02 to 0.1.
